(19) United States
(12) Patent Application Publication
(10) Pub. No.: US 2025/0037024 A1
(43) Pub. Date: Jan. 30, 2025

(54) METHOD AND DEVICE FOR RETRAINING A MACHINE LEARNING SYSTEM

(71) Applicant: Robert Bosch GmbH, Stuttgart (DE)

(72) Inventor: Jan Hendrik Metzen, Boeblingen (DE)

(21) Appl. No.: 18/772,615

(22) Filed: Jul. 15, 2024

(30) Foreign Application Priority Data
Jul. 24, 2023 (DE) 10 2023 207 010.3

(51) Int. Cl. G06N 20/00

(52) U.S. Cl. CPC G06N 20/00

(57) ABSTRACT

A method for gradient-based retraining of a machine learning system with non-public training data with regard to a target task. The method includes: adding further parameters to the pre-trained machine learning system, and adjusting the added further parameters with the non-public training data using a differentially private backpropagation method, wherein the added parameters are adjusted with regard to the target task.

### FIELD

The present invention relates to a method for gradient-based retraining of a machine learning system with non-public training data with regard to a target task. The present invention also relates to a computer program implementing an aforementioned method, to a machine-readable data carrier with such a computer program, and to a computer configured to perform an aforementioned method of the present invention.

### BACKGROUND INFORMATION

Machine learning systems (machine learning (ML) models) generally have the tendency to “remember” information contained in training data. This can manifest in the fact that a machine learning system in the inference reproduces information from the training data in the form of, for example, sentences/certain character strings or image parts/image sections of images from the data set on which the learning system was trained. If non-public data are used in training, sensitive information, for example from personal data or in-house company data, may be revealed in the inference.

arXiv: 1607.00133 [stat.ML] and arXiv: 1911.11607 [cs. LG] propose differentially private training methods for machine learning systems. The methods make possible a balance between information gain from a training datum and restriction of information disclosure to preserve the possible privacy of information from the training data.

### SUMMARY

An advantageous aspect of the present invention relates to the adjustment of a small number of parameters of a machine learning system in the retraining of the machine learning system when using non-public training data in the retraining, since this can lead to a convergence of the adjustment with fewer training steps. Such a reduction in the convergence time is advantageous since less “information” about the non-public (i.e., private) training data used can be incorporated into the adjustment of the parameters if the training is shorter. Furthermore, there is a maximum number of training iterations that can be carried out in a differentially private stochastic gradient descent method (see also arXiv: 1607.00133 [stat.ML]) depending on a specified privacy budget. When adjusting a few, but possibly in particular relevant, parameters of the machine learning system in a retraining according to the present invention, there is a higher probability of adjusting the few parameters to be adjusted in the retraining, within the maximum number of training iterations in such a way that the machine learning system generalizes better in the inference. That is to say, it is possible that a machine learning system trained according to the present invention has better performance with the same specified privacy budget than a machine learning system in which a larger number of parameters were adjusted in the retraining. A privacy budget measures how much the information gain from a training datum is restricted in order to preserve its privacy, and can be determined by specifying the parameters ε and δ, in particular in the case of (ε, δ)-differential privacy (see also doi.org/10.1007/11681878_14). By deliberately adjusting a few parameters on the basis of the non-public information, this non-public information is contained in the machine learning system in a compact and not comprehensive form, which can reduce ‘remembering.’

In a first aspect, the present invention relates to a computer-implemented method for gradient-based retraining of a machine learning system with regard to a target task. Retraining can be used, for example, to adjust the learning system to the generation of synthetic data, e.g., image data, for training an image processor/image classifier. An image classifier can classify or segment images, in particular objects in the image, and/or visually highlight objects. The training data used in the method described here are non-public (hereinafter also referred to as “private”). The training data may thus contain sensitive information, such as personal or internal company information. For example, the training data may comprise patient-related images from medical diagnostics. The training data may also comprise company-owned, non-public images with, for example, driving situations from autonomous driving or images from the automatic visual inspection of workpieces. The training data can also comprise images acquired with a new, possibly specifically adjusted camera sensor. It is also possible that the training data comprise audio data or other sensor data of further modalities, such as data acquired with a radar sensor or a LiDAR sensor. According to a method described here, the machine learning system is provided as a pre-trained model, i.e., the parameters of the machine learning system have been adjusted to a basic task in a pre-training. A basic task may, for example, generally consist of generating an image of which the context or content can be specified but cannot be limited to the representation of specific contents, while the target task in this case may consist of generating specific images with certain content features. Alternatively, a basic task may comprise embedding different modalities, e.g., images and associated texts, into a common representation space, i.e., the basic task consists in ascertaining a suitable mapping of, for example, both images and texts (in general: data of different modalities) into a common representation space. A corresponding target task may then comprise, for example, a classification of image data on the basis of text inputs. The pre-trained machine learning system may in particular be a foundation model (FM). A foundation model comprises a plurality of parameters that are adjusted in a pre-training with a plurality of public basic training data with regard to performing a basic task of the foundation model. In the pre-training of a foundation model, the adjustment of the parameters can in particular take place in a self-supervised manner, i.e., with unlabeled training data. In a retraining, a smaller number of training data is used, wherein the training data of the retraining are adjusted to a specific target task. According to a method described here and below, the training data in the retraining are non-public, i.e., private, training data. In the retraining, the pre-trained parameters of the foundation model can be readjusted, i.e., through the retraining, the pre-trained parameters of a foundation model can each be subjected to a small deviation from the value obtained from the basic training. In a retraining, the adjustment of parameters of the model can take place in a supervised manner, i.e., with labeled training data, wherein self-supervised training for retraining is also possible. In the retraining, some or most of the pre-trained parameters of the foundation model can be retained/frozen, and only the non-retained parameters are adjusted.

According to an example embodiment of the present invention, in a step of the method provided here and below, further parameters are added to the pre-trained machine learning system. The further parameters can be added by inserting at least one additional layer into the architecture of the machine learning system. Alternatively or additionally, further parameters can be added to the machine learning system by splitting at least one weight matrix to be adjusted in the retraining, in a layer of the machine learning system, into a sum with two summands. The first summand is given by an associated pre-trained weight matrix, i.e., a weight matrix of which the parameters have been adjusted in the pre-training and are in particular retained in the retraining. The second summand comprises the matrix product of two further matrices, wherein these two further matrices are parameterized with the further parameters to be adjusted in the retraining. The ranks of the two further matrices are each lower than the rank of the pre-trained weight matrix in the first summand.

The pre-trained weight matrix, to which a further term to be adjusted, given by the matrix product of two further matrices, is added in the aforementioned manner in the retraining, may, for example, be a weight matrix in a transformer layer, in particular a weight matrix in a (self-) attention head of a transformer layer. In a further method step, the added further parameters are adjusted with the non-public training data by means of a differentially private backpropagation method with regard to the target task. In the method described here, only, i.e., exclusively, the added further parameters can in particular be adjusted in the retraining.

An advantage of the method according to the present invention provided here and below, is that a machine learning system can be adjusted with non-public training data to a technical target task efficiently, i.e., possibly with a smaller set of specifically tailored training data and thus in a shorter time, since the non-public training data comprise, for example, image data that relate, possibly exclusively, to specific cases or situations relevant to the target task. For example, non-public image data with driving environments that show a specific safety-critical situation, e.g., with pedestrians, can be used for autonomous driving. Non-public image data from workpiece inspection that, for example, show a specific, rare defect in a workpiece can also be used.

According to a preferred embodiment of the method of the present invention, the differentially private backpropagation method comprises a step-by-step minimization of a cost function. In general, a machine learning system is designed to receive input data and map them to output data by means of mathematical operations in multiple, or usually in a large number of, layers of the machine learning system. In a (pre-/re) training of the machine learning system, a cost function can measure how well the output data ascertained by the learning system match corresponding specified output data.

According to an example embodiment of the present invention, in a step of the differentially private backpropagation method, an averaged and noisy gradient of the cost function can in each case be ascertained. The averaged and noisy gradient can comprise a weighted sum of the contributions of limited magnitude of the gradients of individual non-public training data to the gradient of the cost function and can additionally be subjected to a noise term. A (re) training of a machine learning system by means of a differentially private backpropagation method can generally take place in multiple steps, also called training epochs. Within a step or (training) epoch, a subset, also referred to as a batch, of the training data can in each case be received by the learning system. For each training datum from the batch, the learning system can then ascertain an output datum according to the training task. For example, in an epoch of retraining the machine learning system to adjust parameters added to the learning system, with a differentially private backpropagation method, a batch of non-public training data {x₁, x₂, . . . , x_{N}} may be given. If θ denotes the parameters of the learning system that are to be adjusted, the cost function considered in the course of the backpropagation method (also referred to as a loss function) can be represented as L(θ)=Σᵢ^{N} L(θ, xᵢ) in the corresponding training epoch. θ denotes the parameters to be adjusted. That is to say, θ can, for example, only comprise the further added parameters, while the parameters of the machine learning system that were adjusted in a pre-training are retained/frozen. The parameters θ to be adjusted may be initialized, for example randomly, in a first training epoch. Alternatively, all or some of the parameters to be adjusted may be set to zero in a first training epoch. For each training datum xᵢ of an epoch, the corresponding gradient g(xᵢ)←∇_{θ}L(θ, xᵢ) can then be ascertained. Starting from this gradient, it is possible in each case to ascertain a gradient g̅(xᵢ) which has a limited magnitude and of which the norm assumes at most a specifiable value C according to

$$\overline{g} ( {x}_{i} ) = g ( {x}_{i} ) / max = ( \frac{‖ g ( {x}_{i} ) ‖}{c} ) . ‖ g ( {x}_{i} ) ‖$$

denotes, for example, the L₂ norm of the gradient g(xᵢ). A noise term can be added to the weighted sum of the individual contributions of limited magnitude in order to obtain an averaged and noisy gradient according to

$$\tilde{g} ( {x}_{i} ) = \frac{1}{N} ( {Σ}_{i}^{N} \overline{g} ( {x}_{i} ) + N ( 0 , {σ}^{2} {C}^{2} {I}^{2} ) ) .$$

Here, I denotes a unit matrix and σ specifies a noise scale. For example, the values of the parameters σ and C can be chosen as σ=3 or σ=4 and C=1. According to their experience, a person skilled in the art can choose values for the parameters σ and C other than those mentioned above. By limiting the norm and adding a noise term, the information gain and thus an information content of a training datum that can be memorized by the learning system is limited. In a method proposed here, it is thus possible to use training data with information contained therein that efficiently adjusts a machine learning system to a technical target task without the machine learning system revealing specific information from the corresponding retraining in the inference.

An averaged and noisy gradient, obtained according to one of the steps described above and/or below, with contributions of limited magnitude can be used in a training epoch instead of an averaged gradient usually used in a backpropagation method, in order to adjust the parameters of the machine learning system that are to be adjusted, in the direction opposite to the steepest gradient ascent. By using the averaged and noisy gradient described above and/or below, in a backpropagation process, this method becomes a differentially private backpropagation process, also referred to as a differentially private backpropagation method.

According to a preferred exemplary embodiment of the present invention, two adapter layers are in each case inserted at least in the last L transformer blocks into the architecture of the pre-trained machine learning system. In a transformer block, one adapter layer can be inserted after the out-projection of the self-attention and one after the multi-layer perceptron. For example, L can be given by L=30. The parameters added by inserting the adapter layers can represent further parameters of the machine learning system. These added parameters can be adjusted by means of the differentially private backpropagation method described above and below. For example, each adapter layer can comprise a feed-forward down projection into a bottleneck, a non-linearity, and a feed-forward up projection. In this case, the parameters of the down and up projection that were added by inserting the adapter layers can be adjusted. The non-linearity can be given by reLU, for example. Alternatively, the non-linearity, in particular in the case of transformers, can also be given by GELU (Gaussian error linear unit).

According to an exemplary embodiment of the present invention, a prefix of length K can in each case be prepended to the machine learning system at least in the last L (e.g., L=30) transformer blocks. The key vector and value vector of a self-attention layer within the transformer block can then be modified by the prefix of the associated transformer block. The key vector and the value vector in a self-attention layer of a transformer block can be ascertained by multiplying the input vector, received from the self-attention layer, with the key weight matrix or the value weight matrix of the corresponding self-attention layer. Additionally, a gating mechanism with a scalar parameter can be introduced. Regarding the modification of key vectors and value vectors by the prefix and the gating mechanism; see also arXiv:2303.16199 [cs.CV]. The parameters, associated with the prefix, and the scalar parameter of the gating mechanism are added parameters, which are added to the machine learning system before the retraining and can be adjusted by means of the differentially private backpropagation method.

According to an exemplary embodiment of the present invention, further added parameters to be adjusted in the retraining can be obtained by representing a weight matrix Wᵢ to be adjusted in the retraining, in a layer of the machine learning system, as the sum Wᵢ=W_{i,0}+W_{i,A}·W_{i,B} of a pre-trained weight matrix W_{i,0} and a product of two further matrices, each with a lower rank than the rank of the weight matrix W_{i,0}, wherein the elements of the two further matrices are each added parameters to be adjusted in the retraining. The first term of the sum Wᵢ=W_{i,0}+W_{i,A}·W_{i,B} comprises an A×B weight matrix W_{i,0}, which corresponds to the corresponding layer and the entries of which have been adjusted in the pre-training and are not changed in the retraining. The second term is given by a matrix product of the matrices W_{i,A} and W_{i,B}. Here, W_{i,A} denotes an A×r and W_{i,B} an r×B matrix, the entries of which are respectively added parameters, which are adjusted by means of the differentially private backpropagation method. r denotes a freely selectable hyperparameter that determines the rank of the matrices W_{i,A}, W_{i,B}. The hyperparameter r can take a value smaller than the value of the rank of the matrix W_{i,0}. Preferably, r can, for example, take a value of r≤16. For example, r can take a value of r=4. For example, the added parameters, i.e., the entries, of a matrix W_{i,A} can be initialized randomly (e.g., in a Gaussian-distributed manner). The parameters, i.e., matrix entries, of a matrix W_{i,B} can be set to zero initially, i.e., at the beginning of the retraining.

According to an exemplary embodiment of the present invention, a particularly suitable value for the hyperparameter r introduced in the previous exemplary embodiment can be ascertained/determined first. For this purpose, a method described in the previous exemplary embodiment can be performed with public training data multiple times with in each case different, specified values of the hyperparameter r. For example, the method can in each case be performed with a value of r=1, 2, . . . 16. In this way, multiple machine learning systems M^{r} can be obtained, each with adjusted, added parameters. The machine learning systems M^{r} can be validated on public validation data, e.g., by ascertaining an associated performance metric. The public validation data do not match the public training data used in the retraining of the machine learning systems M^{r}, i.e., the public validation data do not contain any training datum from the aforementioned public training data. The ascertained performance metrics of the machine learning systems M^{r} can be compared to one another, and the r for which the corresponding model M^{r} has the best performance metric can be selected. The method steps, described in the context of the previous exemplary embodiment, for adjusting the added parameters in the matrices W_{i,A}, W_{i,B} with non-public training data can then be performed with the selected hyperparameter r.

Furthermore, the present invention also relates to a computer program comprising machine-readable instructions which, when executed on one or more computers, cause the computer(s) to perform one of the methods according to the present invention described above and below. The present invention also comprises a machine-readable data carrier on which the above computer program is stored, as well as a computer equipped with the aforementioned computer program and/or the aforementioned machine-readable data carrier.

Example embodiments of the present invention will be explained in detail below with reference to the figures.

### BRIEF DESCRIPTION OF THE DRAWINGS

FIG. 1 shows a schematic information flow overview of a method according to an example embodiment of the present invention described here.

FIG. 2 schematically shows a device for performing a method according to an example embodiment of the present invention described here.

### DETAILED DESCRIPTION OF EXAMPLE EMBODIMENTS

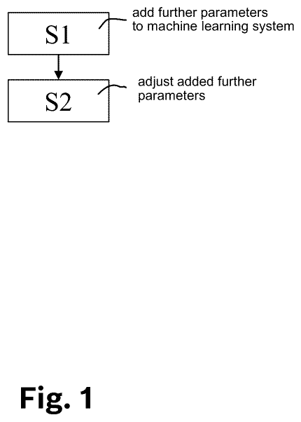

FIG. 1 shows an information flow overview of a method for gradient-based retraining of a machine learning system with non-public training data with regard to a target task. The machine learning system comprises pre-trained parameters, which have been adjusted in a pre-training of the learning system to performing a basic task. In method step S1, further parameters are added to the machine learning system. This can be done by inserting at least one additional layer into the architecture of the learning system. Alternatively or additionally, the further parameters can be added in step S1 by representing a weight matrix to be adjusted in the retraining, in a layer of the machine learning system, as the sum of a pre-trained weight matrix and an additional weight matrix, and representing this additional weight matrix as a product of two further matrices, each with a lower rank; in this case, further added parameters are given by the elements of the two further matrices. In step S2, the added further parameters are adjusted with regard to the target task with the non-public training data by means of a differentially private backpropagation method.

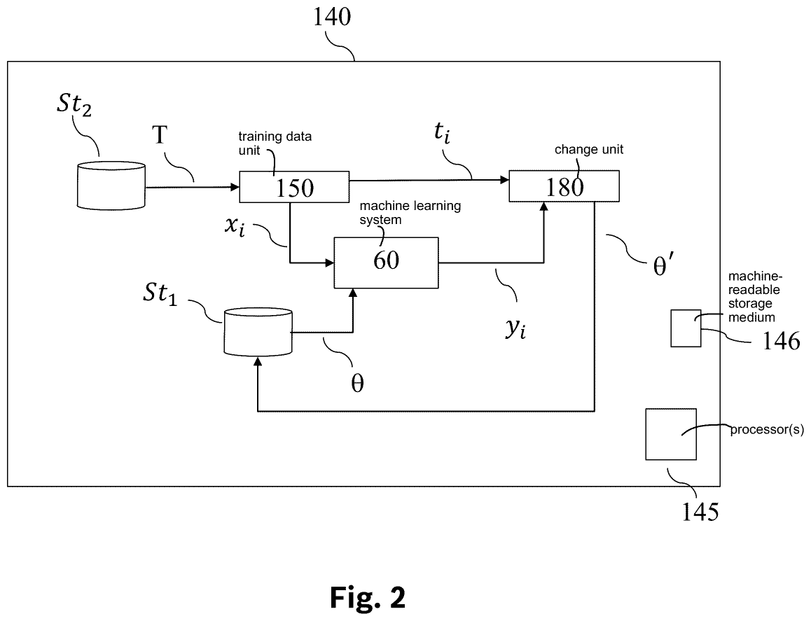

FIG. 2 shows an exemplary embodiment of a device 140 for performing a method described here for gradient-based retraining of a machine learning system 60 with non-public training data T with regard to a target task. The parameters of the machine learning system 60 have been adjusted to a basic task in a pre-training with, for example, public training data. The non-public training data T in the retraining of the machine learning system comprise a plurality of input signals xᵢ, which are used within the framework of a method described here, for retraining the machine learning system 60 by means of a differentially private backpropagation method. The set of non-public training data, T, may furthermore comprise, for each input signal xᵢ, a desired output signal tᵢ, which corresponds to the input signal xᵢ and can characterize a classification of the input signal xᵢ.

If a basic task consists, for example, in generating an image of which the context or content can be specified but cannot be limited to the representation of specific contents, a target task in this case can consist in generating specific images with certain content features, such as driving situations, images of workpieces in workpiece inspection, or images for medical diagnostics (thorax X-rays, etc.).

Further parameters θ to be adjusted in the retraining are added to the parameters of the machine learning system 60 that have already been adjusted in a pre-training. This can be done by inserting at least one additional layer into the architecture of the learning system. Alternatively or additionally, further parameters can be obtained by representing a weight matrix to be adjusted in the retraining, in a layer of the machine learning system, as the sum of a pre-trained weight matrix and a matrix product of two further matrices, each with a lower rank, and by the elements of the two further matrices in this case specifying added further parameters.

For retraining, a training data unit 150 accesses a computer-implemented database St₂, wherein the database St₂ provides the data set of non-public training data T. The training data unit 150 preferably randomly ascertains at least one input signal xᵢ and the corresponding desired output signal tᵢ from the non-public training data set T and transmits the input signal xᵢ to the machine learning system 60. The machine learning system 60 ascertains an output signal yᵢ on the basis of the input signal xᵢ.

The desired output signal tᵢ and the ascertained output signal yᵢ are transmitted to a change unit 180.

On the basis of the desired output signal tᵢ and the ascertained output signal yᵢ, new parameters θ′ for the machine learning system 60 are then determined by the change unit 180. For this purpose, the change unit 180 compares the desired output signal tᵢ and the ascertained output signal yᵢ by means of a cost function (loss function). The cost function ascertains a first loss value that characterizes how much the ascertained output signal yᵢ deviates from the desired output signal tᵢ.

The change unit 180 ascertains the new parameters θ′ on the basis of the first loss value by means of a differentially private backpropagation method. In the exemplary embodiment, this is done by using an averaged, noisy gradient with contributions of limited magnitude of individual training data in a gradient descent method, preferably stochastic gradient descent, Adam, or AdamW, in each case.

The ascertained new parameters θ′ are stored in a model parameter memory St₁. The described training is preferably repeated iteratively for a predefined number of iteration steps or repeated iteratively until the first loss value falls below a predefined threshold value. Alternatively or additionally, it is also possible that the training is terminated when an average first loss value for a test or validation data set falls below a predefined threshold value. In at least one of the iterations, the new parameters θ′ determined in a previous iteration are used as parameters θ of the machine learning system 60.

Furthermore, the device 140 may comprise at least one processor 145 and at least one machine-readable storage medium 146 containing instructions that, when executed by the processor 145, cause the device 140 to perform a method according to one of the aspects of the present invention.

The term “computer” includes any device for processing specifiable calculation rules. These calculation rules can be in the form of software, or in the form of hardware, or even in a mixed form of software and hardware.

In general, a plurality can be understood as indexed, i.e., each element of the plurality is assigned a unique index, preferably by assigning consecutive integers to the elements contained in the plurality. Preferably, when a plurality comprises N elements, where N is the number of elements in the plurality, the elements are assigned integers from 1 to N.

1-9. (canceled)

10. A computer-implemented method for gradient-based retraining of a machine learning system with non-public training data with regard to a target task, wherein parameters of the machine learning system have been adjusted to a basic task in a pre-training, the method comprising the following steps:
adding further parameters to the pre-trained machine learning system, wherein (i) the further parameters are added by inserting at least one additional layer, parameterized with the further parameters, into an architecture of the learning system, and/or (ii) the further parameters are added by splitting at least one weight matrix to be adjusted in the retraining, in a layer of the machine learning system, into a sum of a pre-trained weight matrix and a further summand added in the retraining, wherein the further summand is given by the matrix product of two further matrices, wherein the two further matrices are parameterized with the further parameters, wherein parameters of the pre-trained weight matrix have been adjusted in the pre-training and are retained in the retraining, wherein ranks of the two further matrices are each lower than the rank of the pre-trained weight matrix; and
adjusting the added further parameters with the non-public training data using a differentially private backpropagation method, wherein the added parameters are adjusted with regard to the target task.

11. The method according to claim 10, wherein the differentially private backpropagation method includes a step-by-step minimization of a cost function, wherein, in one step of the backpropagation method, an averaged and noisy gradient of the cost function is in each case ascertained, wherein the averaged and noisy gradient: (i) includes a weighted sum of the contributions of limited magnitude of the gradients of individual non-public training data to the gradient of the cost function, and (ii) is subjected to an additional noise term.

12. The method according to claim 10, wherein two adapter layers are in each case inserted at least in last L transformer blocks into the architecture of the pre-trained machine learning system, and wherein the parameters added by inserting the adapter layers are adjusted using the differentially private backpropagation method.

13. The method according to claim 12, wherein the machine learning system is in each case prepended by a prefix of length at least in the last L transformer blocks, wherein a key vector and a value vector in a self-attention layer of a transformer block can in each case be modified by a prefix of the associated transformer block, wherein an additional gating mechanism with a scalar parameter is introduced, wherein parameters associated with the prefix and the scalar parameter of the gating mechanism are the added parameters which are adjusted with the differentially private backpropagation method.

14. The method according to claim 10, wherein the further parameters are added by splitting a weight matrix Wᵢ to be adjusted in the retraining, in a layer of the machine learning system, into a sum Wᵢ=W_{i,0}+W_{i,A}·W_{i,B} of a pre-trained weight matrix W_{i,0} and a product of two further matrices, each with a lower rank than the rank of the weight matrix W_{i,0}, wherein the elements of the two further matrices are each added parameters to be adjusted in the retraining, wherein:
W_{i,0} denotes an A×B weight matrix of the machine learning system, which corresponds to the layer and the entries of which have been adjusted in the pre-training and are not changed,
W_{i,A} denotes an A×r matrix and W_{i,B} an r×B matrix, the entries of which are added parameters, which are adjusted with regard to the target task by means of the differentially private backpropagation method,
r is a freely selectable hyperparameter determining a rank of the matrices W_{i,A}, W_{i,B}.

15. The method according to claim 10, wherein the hyperparameter r is first ascertained according to the following method steps:
performing multiple times:
adding the further parameters by splitting a weight matrix Wᵢ to be adjusted in the retraining, in a layer of the machine learning system, into a sum Wᵢ=W_{i,0}+W_{i,A}·W_{i,B} of a pre-trained weight matrix W_{i,0} and a product of two further matrices, each with a lower rank than the rank of the weight matrix W_{i,0}, wherein the elements of the two further matrices are each added parameters to be adjusted in the retraining, wherein:
W_{i,0} denotes an A×B weight matrix of the machine learning system, which corresponds to the layer and the entries of which have been adjusted in the pre-training and are not changed,
W_{i,A} denotes an A×r matrix and W_{i,B} an r×B matrix, the entries of which are added parameters, which are adjusted with regard to the target task by means of the differentially private backpropagation method,
r is a freely selectable hyperparameter determining a rank of the matrices W_{i,A}, W_{i,B},
with in each case different specified values of the hyperparameter r and with public training data so that a machine learning system with adjusted added parameters is obtained in each case;
validating the obtained machine learning systems on public validation data in each case by ascertaining an associated performance metric;
selecting the hyperparameter r for the obtained learning system with a best performance metric;
performing the adding of the parameters by splitting for adjusting the added parameters of the machine learning system with non-public training data with the selected hyperparameter r.

16. A device configured for gradient-based retraining of a machine learning system with non-public training data with regard to a target task, wherein parameters of the machine learning system have been adjusted to a basic task in a pre-training, the device configured to:
add further parameters to the pre-trained machine learning system, wherein (i) the further parameters are added by inserting at least one additional layer, parameterized with the further parameters, into an architecture of the learning system, and/or (ii) the further parameters are added by splitting at least one weight matrix to be adjusted in the retraining, in a layer of the machine learning system, into a sum of a pre-trained weight matrix and a further summand added in the retraining, wherein the further summand is given by the matrix product of two further matrices, wherein the two further matrices are parameterized with the further parameters, wherein parameters of the pre-trained weight matrix have been adjusted in the pre-training and are retained in the retraining, wherein ranks of the two further matrices are each lower than the rank of the pre-trained weight matrix; and
adjust the added further parameters with the non-public training data using a differentially private backpropagation method, wherein the added parameters are adjusted with regard to the target task.

17. A non-transitory machine-readable medium on which is stored a computer program for gradient-based retraining of a machine learning system with non-public training data with regard to a target task, wherein parameters of the machine learning system have been adjusted to a basic task in a pre-training, the computer program, when executed by a processor, causing the processor to perform the following steps:
adding further parameters to the pre-trained machine learning system, wherein (i) the further parameters are added by inserting at least one additional layer, parameterized with the further parameters, into an architecture of the learning system, and/or (ii) the further parameters are added by splitting at least one weight matrix to be adjusted in the retraining, in a layer of the machine learning system, into a sum of a pre-trained weight matrix and a further summand added in the retraining, wherein the further summand is given by the matrix product of two further matrices, wherein the two further matrices are parameterized with the further parameters, wherein parameters of the pre-trained weight matrix have been adjusted in the pre-training and are retained in the retraining, wherein ranks of the two further matrices are each lower than the rank of the pre-trained weight matrix; and
adjusting the added further parameters with the non-public training data using a differentially private backpropagation method, wherein the added parameters are adjusted with regard to the target task.
